(19) United States
(12) Patent Application Publication
(10) Pub. No.: US 2005/0225656 A1
(43) Pub. Date: Oct. 13, 2005

(54) Imaging sensor

(75) Inventor: Mikio Ihama, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/098,470

(22) Filed: Apr. 5, 2005

(30) Foreign Application Priority Data
Apr. 7, 2004 (JP) P.2004-112806

(51) Int. Cl. H04N 5/335

(52) U.S. Cl. 348/272

(57) ABSTRACT

An imaging sensor having a stacked structure of at least three layers capable of absorbing/photoelectrically converting electromagnetic waves of at least blue light, green light and red light, and further comprising at least one construction selected from those where at least one of an ultraviolet absorbing layer, an infrared absorbing layer, a black visible light absorbing layer, a fourth electromagnetic wave absorption/photoelectric conversion layer and a yellow filter layer is provided, or where the electromagnetic wave absorption/photoelectric conversion portion is separated into two layers of high-sensitivity layer and low-sensitivity layer.

This application is based on Japanese Patent application JP 2004-112806, filed Apr. 7, 2004, the entire content of which is hereby incorporated by reference. This claim for priority benefit is being filed concurrently with the filing of this application.

### BACKGROUND OF THE INVENTION

1.Technical Field of the Invention

The present invention relates to a solid-state imaging device having a photoconductive film, more specifically, the present invention relates to a solid-state imaging device comprising a layer structure contributing to enhancement of the image quality.

2. Description of the Related Art

The imaging system using a camera and a silver salt photosensitive material as represented by a color negative photosensitive material or a color reversal photosensitive material is being taken the place of by a digital camera using a solid-state imaging system such as CCD and CMOS because of convenience. However, in most of the methods of using a mosaic-like color filter for the single plate-type sensor employed in the solid-state imaging system, high resolution cannot be obtained because one pixel of the light-receiving element responds to any one of blue light, green light and red light, and from the aspect of pixel unit, the incident light at wavelengths other than the desired color is absorbed by the color filter and cannot be effectively utilized. From these and other reasons, this system is inferior to the imaging system using a silver salt photosensitive material and a camera in view of sensitivity and pictorial quality.

In order to solve these problems, a solid-state color imaging device enhanced in the sensitivity by having a three-layer four-story structure is disclosed, where the electromagnetic wave absorption/photoelectric conversion portion has a stacked structure of three layers capable of absorbing and photoelectrically conversing blue light, green light and red light, respectively, and a charge transfer/read-out portion is provided under the stacked structure (see, for example, JP-A-58-103165 and JP-A-2003-234460(the term “JP-A” as used herein means an “unexamined published Japanese patent application”)).

However, in view of color reproduction, resolution and dynamic range, the level of the silver salt system cannot be attained by only the technique disclosed above, and more improvements are necessary.

### SUMMARY OF THE INVENTION

A first object of the present invention is to elevate color reproduction and resolution of an imaging sensor having a stacked structure to the level practically equal to or higher than the imaging system using a silver salt photosensitive material and a camera. A second object of the present invention is to enhance the dynamic range of the above-described imaging sensor to surpass the imaging system using a silver salt photosensitive material and a camera.

The present inventors have found that when in an imaging sensor having a stacked structure of at least three layers capable of absorbing/photoelectrically converting electromagnetic waves of at least blue light, green light and red light, at least any one of an ultraviolet absorbing layer, an infrared absorbing layer, a black visible light absorbing layer, a fourth electromagnetic wave absorbing/photoelectric conversion layer and a yellow filter layer is further provided, the color reproduction and resolution are enhanced. It has been also found that when at least one layer constituting the electromagnetic wave absorption/photoelectric conversion portion is separated into two layers of high-sensitivity layer and low-sensitivity layer, the dynamic range is enhanced. That is, the above-described objects can be attained by the following (1) to (13).

(1) An imaging sensor, which is a multipixel imaging sensor comprising an electromagnetic wave absorption/photoelectric conversion portion and a charge transfer/read-out portion, wherein the electromagnetic wave absorption/photoelectric conversion portion has a stacked structure of at least three layers capable of absorbing and photoelectrically converting at least blue light, green light and red light, respectively, and further comprises an ultraviolet absorbing layer on the uppermost layer of the electromagnetic wave absorption/photoelectric conversion portion.

(2) An imaging sensor, which is a multipixel imaging sensor comprising an electromagnetic wave absorption/photoelectric conversion portion and a charge transfer/read-out portion, wherein the electromagnetic wave absorption/photoelectric conversion portion has a stacked structure of at least three layers capable of absorbing and photoelectrically converting at least blue light, green light and red light, respectively, and further comprises an infrared absorbing layer on the uppermost layer of the electromagnetic wave absorption/photoelectric conversion portion.

(3) An imaging sensor, which is a multipixel imaging sensor comprising an electromagnetic wave absorption/photoelectric conversion portion and a charge transfer/read-out portion, wherein the electromagnetic wave absorption/photoelectric conversion portion has a stacked structure of at least three layers capable of absorbing and photoelectrically converting at least blue light, green light and red light, respectively, and further comprises a black visible light absorbing layer on the lowermost layer of the electromagnetic wave absorption/photoelectric conversion portion.

(4) An imaging sensor, which is a multipixel imaging sensor comprising an electromagnetic wave absorption/photoelectric conversion portion and a charge transfer/read-out portion, wherein the electromagnetic wave absorption/photoelectric conversion portion has a stacked structure of at least three layers capable of absorbing and photoelectrically converting at least blue light, green light and red light, respectively, and further comprises a fourth electromagnetic wave absorption/photoelectric conversion portion layer of absorbing light at a spectral wavelength different from the spectral absorption wavelength of those three layers.

(5) An imaging sensor, which is a multipixel imaging sensor comprising an electromagnetic wave absorption/photoelectric conversion portion and a charge transfer/read-out portion, wherein the electromagnetic wave absorption/photoelectric conversion portion has a stacked structure of at least three layers capable of absorbing and photoelectrically converting at least blue light, green light and red light, respectively, and further comprises a yellow filter layer as a lower layer of the electromagnetic wave absorption/photoelectric conversion portion.

(6) An imaging sensor, which is a multipixel imaging sensor comprising an electromagnetic wave absorption/photoelectric conversion portion and a charge transfer/read-out portion, wherein the electromagnetic wave absorption/photoelectric conversion portion has a stacked structure of at least three layers capable of absorbing and photoelectrically converting at least blue light, green light and red light, respectively, and at least one layer of the electromagnetic wave absorption/photoelectric conversion portion comprises two or more layers of a high-sensitivity layer and a low-sensitivity layer.

(7) The imaging sensor as described in any one of (1) to (6) above, wherein the charge transfer/read-out portion is a Group IV, III-V or II-VI semiconductor having a charge mobility of 100 cm²/V.s or more.

(8) The imaging sensor as described in any one of (1) to (7) above, wherein the charge transfer/read-out portion is a silicon device.

(9) The imaging sensor as described in any one of (1) to (8) above, wherein the charge transfer/read-out portion has a CMOS structure or a CCD structure.

(10) The imaging sensor as described in any one of (1) to (8) above, wherein the electromagnetic wave absorption/photoelectric conversion portion comprises a unit consisting of an organic compound film and light-transmitting electrodes sandwiching the film.

(11) The imaging sensor as described in any one of (1) to (10) above, wherein the electromagnetic wave absorption/photoelectric conversion portion comprises a unit consisting of an organic compound-inorganic compound mixed film and light-transmitting electrodes sandwiching the film.

(12) The imaging sensor as described in any one of (1) to (10) above, wherein the electromagnetic wave absorption/photoelectric conversion portion comprises a unit consisting of an inorganic compound film and light-transmitting electrodes sandwiching the film.

(13) The imaging sensor as described in any one of (1) to (12) above, wherein the electromagnetic wave absorption/photoelectric conversion portion and the charge transfer/read-out portion are electrically connected by an electrically conducting material.

In the imaging sensor of the present invention where the electromagnetic wave absorption/photoelectric conversion portion has a stacked structure of at least three layers capable of absorbing and photoelectrically converting at least blue light, green light and red light, respectively, and further comprises a layer selected from an ultraviolet absorbing layer, an infrared absorbing layer, a black visible light absorbing layer, another color light absorbing layer, a yellow filter layer and a low-sensitivity second layer, the color reproduction and resolution can be elevated to the level practically equal to or higher than the imaging system using a silver salt photosensitive material and a camera, or the dynamic range can be enhanced to the level equal to or higher than the latitude of the imaging system using a silver salt photosensitive material and a camera.

### DETAILED DESCRIPTION OF THE INVENTION

The imaging sensor of the present invention is described below.

In the present invention, the electromagnetic wave absorption/photoelectric conversion portion has a stacked structure of at least three layers capable of absorbing and photoelectrically converging at least blue light, green light and red light. The blue light absorbing layer (B) can absorb light at least at 400 to 500 nm, and the absorption factor at the peak wavelength in this wavelength region is preferably 50% or more. The green light absorbing layer (G) can absorb light at least at 500 to 600 nm, and the absorption factor at the peak wavelength in this wavelength region is preferably 50% or more. The red light absorbing layer (R) can absorb light at least at 600 to 700 nm, and the absorption factor at the peak wavelength in this wavelength region is preferably 50% or more. These layers may be in any order, and the order from the upper layer may be BGR, BRG, GBR, GRB, RBG or RGB. Preferably, the uppermost layer is the blue light absorbing layer (B). Each light absorbing layer itself is a photoconductive film capable of transferring electrons or holes generated by the photoelectric conversion of light absorbed, or each light absorbing layer has a photoconductive film capable of transferring electrons or holes. Each electromagnetic wave absorption/photoelectric conversion portion has a pair of electrodes on both sides of the photoconductive film and produces a photoelectric current with use of light absorbed by the photoconductive film. The electrodes of different photoconductive films are insulated from each other by an insulating layer.

The imaging sensor of the present invention in a first embodiment includes at least one additional layer, that is, includes an ultraviolet absorbing layer and/or an infrared absorbing layer on the uppermost layer of the electromagnetic wave absorption/photoelectric conversion portion, includes a black visible light absorbing layer on the lowermost layer of the electromagnetic wave absorption/photoelectric conversion portion, or includes a yellow filter as a lower layer of the electromagnetic wave absorption/photoelectric conversion portion of absorbing blue light.

The ultraviolet absorbing layer can absorb ultraviolet light at least at 400 nm or less, and the absorption factor in the ultraviolet wavelength region of 400 nm or less is preferably 50% or more. The infrared absorbing layer can absorb infrared light at least at 700 nm or more, and the absorption factor in the infrared wavelength region of 700 nm or more is preferably 50% or more. The black visible light absorbing layer can absorb ultraviolet light at least at 400 to 700 nm, and the absorption factor in this wavelength region is preferably 50% or more. The yellow filter layer can absorb light at least at 400 to 500 nm, and the absorption factor at the peak wavelength in this wavelength region is preferably 50% or more.

These ultraviolet absorbing layer, infrared absorbing layer, black visible light absorbing layer and yellow filter layer can be formed by a conventionally known method. That is, the colored layer can be formed by adding or dying a dye having a desired absorption wavelength to a constituent material (binder) for ultraviolet absorbing layer, infrared absorbing layer, black visible light absorbing layer or yellow filter layer, which constituent material is known in the photographic field or the like, for example, in the case of the filter layer, a hydrophilic polymer substance such as gelatin, casein, glue or polyvinyl alcohol.

Also, a method using a colored resin obtained by dispersing a certain colorant in a transparent resin is known. For example, as disclosed in JP-A-58-46325, JP-A-60-78401, JP-A-60-184202, JP-A-60-184203, JP-A-60-184204 and JP-A-60-184205, a colored resin film obtained by mixing a colorant in a polyamide-based resin can be used. A coloring agent using a polyimide resin having photo-sensitivity may also be used.

Furthermore, the technique described in JP-B-7-113685 (the term “JP-B” as used herein means an “examined Japanese patent publication”) of dispersing a coloring material in an aromatic polyamide resin which contains a group having photosensitivity within the molecule and can give a cured film at 200° C. or less, and curing the dispersion to form a colored film, and the technique described in JP-B-7-69486 of dispersing a pigment in a colored resin and film-forming the dispersion may also be used.

By providing the ultraviolet absorbing layer, infrared absorbing layer, black visible light absorbing layer or yellow filter layer, light at wavelengths of different colors can be efficiently separated and color mixing can be prevented, as a result, high resolution with good color reproducibility can be obtained.

More specifically, when the ultraviolet absorbing layer is provided on the uppermost layer of the electro-magnetic wave absorption/photoelectric conversion portion, photosensitive layers of absorbing and photoelectrically converting red light, blue light and green light, respectively, are protected from exposure to ultraviolet light and sensitized only with light of respective colors to generate an electrical signal of the corresponding color, so that the imaging element can be prevented from distortion of color signal due to ultraviolet light imperceptible to human auditory sense.

Similarly, when the infrared absorbing layer is provided on the uppermost layer of the electromagnetic wave absorption/photoelectric conversion portion, photosensitive layers of absorbing red light, blue light and green light, respectively, are protected from exposure to infrared light, and the infrared light imperceptible to human visual sense is prevented from generating red, blue and green signals in the imaging element and distorting the image.

When the black visible light absorbing layer is provided on the lowermost layer of the electromagnetic wave absorption/photoelectric conversion portion, the imaging element can get rid of a trouble that light not absorbed by photosensitive layers of respective colors but reached the semiconductor substrate generates a false image signal on the substrate and this affects the image signal of the charge transfer circuit to give color turbidity to the reproduced image.

Also, in the case of a general layer structure where a photosensitive layer of absorbing blue light is disposed on the outermost surface side and photosensitive layers of absorbing green light and red light, respectively, are subsequently disposed, when a yellow filter layer is provided under the blue-absorbing photosensitive layer, the imaging element can get rid of a trouble that blue light transmitted through the blue-absorbing photosensitive layer exposes the green- or red-absorbing photosensitive layer and a blue color is mixed in the green and/or red reproduced image.

The thickness of each of these ultraviolet, infrared, black and yellow filter layers is preferably smaller as long as the absorbance can satisfy the preferred conditions described above, and the thickness is preferably 3 μm or less, more preferably 1 μm or less.

In the present invention, it is possible that the electromagnetic wave absorption/photoelectric conversion portion has a stacked structure of at least three layers and additionally comprises a fourth electromagnetic wave absorption/photoelectric conversion layer (C), and also possible that at least one layer of the electromagnetic wave absorption/photoelectric conversion portion is separated into two layers of high-sensitivity layer (O) and low-sensitivity layer (U). Similarly to the above-described freely arrangeable order of B, G and R layers, the order of C, O and U layers can be freely arranged. Also, the O and U layers may be separated by another color-sensitive layer.

The absorption wavelength and signal processing of the fourth electromagnetic wave absorption/photoelectric conversion portion can be determined or performed by referring to Japanese Patent No. 2872759 stating that the negative spectral stimulus values of RGB color system can be compensated by arithmetically processing the quantity of light absorbed by respective photosensitive layers. When the fourth electromagnetic wave absorption/photoelectric conversion layer (C) is provided and the arithmetic processing including the quantity of light absorbed by the layer is performed, negative spectral sensitivity corresponding to human eye can be realized and the color reproducibility is enhanced.

The fourth electromagnetic absorption/photoelectric conversion layer (C) preferably has a spectral absorption region corresponding to the spectral region from 450 to 530 μm of negative stimulus value present in the R stimulus value of the RGB color system, and when the spectral sensitivity is adjusted to this range, the negative stimulus value can be compensated by subtracting at a constant ratio the stimulus value generated by the fourth electromagnetic absorption/photoelectric conversion layer (C) from the stimulus value generated by the red-sensitive electromagnetic wave absorption/photoelectric conversion layer, whereby the human visual sense can be approximated.

As for the high-sensitivity layer and low-sensitivity layer, it may suffice to provide two substantially the same electromagnetic wave absorption/photoelectric conversion portion layers. Preferably, the layer positioned at the upper layer is the high-sensitivity layer, and the layer positioned at the lower layer is the low-sensitivity layer. By constructing a two-layer structure from two layers differing in the sensitivity, the dynamic range is widened. In the case where the difference in the sensitivity between high-sensitivity layer and low-sensitivity layer is 1,000:1 and the dynamic range of each single layer is 3.0 by logarithmic indication, a value of 6.0 which is the dynamic range of the commercially available silver salt negative film having a maximum pictorial quality can be theoretically achieved by superposing the layers.

The electromagnetic wave absorption/photoelectric conversion portion is not particularly limited in the material as long as the material has its functions, and, for example, an Si-based material, a GaAs-based material, a Ge-based material, an InAs-based material or an organic material can be used. Also, a construction where the above-described dye having a function of absorbing light is added to the appropriately selected material may be employed.

Examples of the construction for the electromagnetic wave absorption/photoelectric conversion portion using such a material include those constructed by i) a unit comprising an organic compound film and light-transmitting electrodes sandwiching the film, ii) a unit comprising an organic compound-inorganic compound mixed film and light-transmitting electrodes sandwiching the film, or iii) a unit comprising an inorganic compound film and light-transmitting electrodes sandwiching the film.

In the case of i) above of using an organic material for the electromagnetic wave absorption/photoelectric conversion portion, the electromagnetic wave absorption/photoelectric conversion portion is preferably formed of an organic compound film. Specifically, PN junction of organic thin film described, for example, in Appl. Phys. Lett., Vol. 48, page 183 (1986), J. Appl. Phys., Vol. 72, page 3781 (1992), Appl. Phys. Lett., Vol. 78, page 2650 (2000), and Appl. Phys. Lett., Vol. 80, page 1667 (2002) can be used.

The electromagnetic wave absorption/photoelectric conversion portion in another preferred embodiment is formed of an organic compound-inorganic compound mixed film of ii) above. Conventional techniques regarding the solar cell known by the name of Graetzel cell can be applied to this embodiment. Specifically, such techniques are described, for example, in JP-A-2000-100487, JP-A-2000-323190, JP-A-2001-35550, JP-A-2001-357896, JP-A-2002-280587, JP-A-2001-168359, JP-A-2001-196612 and JP-A-2001-230435.

The electromagnetic wave absorption/photoelectric conversion portion in another preferred embodiment is formed of an inorganic compound film of iii) above. Specifically, this is described, for example, in Japanese Patent No. 3,405,099.

In the electromagnetic wave absorption/photoelectric conversion portion, each layer is preferably sandwiched by transparent electrodes, and preferred examples of the electrode material include indium tin oxide, indium oxide and tin oxide. Also, a translucent electrode having a thickness of approximately from 20 to 80 nm may be formed by using a metal such as aluminum, vanadium, gold, silver, platinum, iron, cobalt, carbon, nickel, tungsten, palladium, magnesium, calcium, tin, lead, titanium, yttrium, lithium, ruthenium and manganese, or an alloy thereof. Furthermore, the electrode may be formed by using an electrically conducting polymer as represented by polyacetylene type, polyaniline type, polypyrrole type and polythiophene type.

The electromagnetic wave absorption/photoelectric conversion portions are separated from each other by an insulating layer. The insulating layer may be formed by using a transparent insulating material such as glass, polyethylene, polyethylene terephthalate, polyethersulfone and polypropylene.

The charge transfer/read-out portion is preferably a Group IV, III-V or II-VI semiconductor having a charge mobility of 100 cm²/V.s or more. If the charge mobility is less than 100 cm²/V.s, the charge transfer/read-out is disadvantageously retarded. On the other hand, a higher charge mobility is more preferred.

Specifically, this protion is preferably a silicon device, more preferably a silicon device having a CMOS structure or a CCD structure.

Such a semiconductor device is described, for example, in JP-A-58-103166, JP-A-58-103165 and JP-A-2003-332551. A construction where an MOS transistor is formed in each pixel unit on a semiconductor substrate, or a construction having CCD as an element may be appropriately employed. For example, in the case of a solid-state imaging element using MOS transistor, electric charge is generated in the photoconductive film by the effect of incident light transmitted through the electrode, the electric charge travels thorough the photoconductive film to the electrode by the effect of electric field generated between electrode and electrode upon application of a voltage to the electrodes, further moves to the charge accumulation part of MOS transistor and is accumulated in the charge accumulation part. The charge accumulated in the charge accumulation part moves to the charge read-out part by switching of the MOS transistor and is output as an electrical signal, whereby full color image signals are input into a solid-state imaging device including a signal processing part.

### EXAMPLES

The present invention is described in greater detail below by referring to Examples, but the present invention is not limited to the following Examples.

1. Preparation of Titanium Dioxide Liquid Dispersion

Into a stainless steel-made vessel having an internal volume of 200 ml with the inner side being coated with Teflon (registered trademark), 15 g of titanium dioxide (P-25, produced by Degussa and supplied from Nippon Aerosil Co., Ltd.), 45 g of water, 1 g of dispersant (Triton X-100, produced by Aldrich) and 30 g of zirconia beads (produced by Nikkato Corp.) having a diameter of 0.5 mm were charged and dispersed at 1,500 rpm for 2 hours by using a sand grinder mill (manufactured by Imex Co., Ltd.). Subsequently, zirconia beads were removed from the dispersion. At this time, the average particle diameter of the titanium dioxide dispersion was 2.5 μm (particle diameter of primary particles: from 20 to 30 nm). The particle diameter here was a value as measured with use of Master Sizer manufactured by Malvern.

2. Production of Dye-Adsorbed TiO₂ Electrode

After a part (5 mm from end) on the electrically conducting surface side of an electrically conducting glass (produced by Nippon Sheet Glass Co., Ltd., 25 mm×100 mm, surface resistivity: 10 Ω/square) coated with a fluorine-doped tin oxide was covered with a glass and thereby protected, a titanium dioxide thin film (thickness: 60 nm) was formed by a spray-pyrolysis method described in Electrochim. Acta, Vol. 40, pp. 643-652 (1995). Thereafter, a pressure-sensitive adhesive tape was fixed to a part (3 mm from end) on the electrically conducting surface side to serve as a spacer, and the titanium dioxide liquid dispersion prepared above was coated thereon with use of a glass bar. After the completion of coating, the pressure-sensitive adhesive tape was separated, and the resulting glass was air-dried at room temperature for 1 hour, placed in an electric furnace (Muffle Furnace Model FP-32, manufactured by Yamato Scientific Co., Ltd.) and fired at 550° C. for 30 minutes. Subsequently, the glass was taken out, cooled for 7 minutes and then dipped in an ethanol solution (3×10⁻⁴ mol/liter) of Ru Complex Dye (R-1) at room temperature for 12 hours. The dye-adsorbed glass was washed with acetonitrile, naturally dried and cut into 25 mm×10 mm (width) to obtain Electrode A. The thickness of the thus-obtained photosensitive layer (dye-adsorbed titanium dioxide layer) was 1.0 μm, and the coated amount of the semiconductor fine particle was 1.5 g/m². 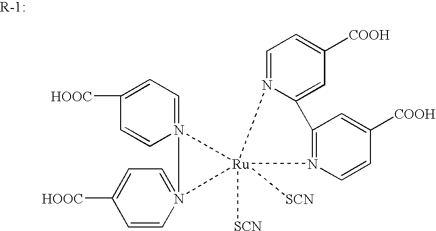
2. Formation of Charge Transport Layer

The charge transport layer was formed by the following method. Thiocyanate (T-1) was added to an acetonitrile solution (3.2 mass %) of CuI to have a proportion of 3 mol % based on the CuI and then dissolved to produce a coating solution. Electrode A produced through previous two steps of this Example was, after protecting the exposed portion on the electrically conducting surface and the 1 mm-width periphery of the cell with a pressure-sensitive adhesive tape, placed on a hot plate heated to 100° C. and then left standing for 2 minutes. Thereafter, 0.2 ml of the coating solution was gradually added over about 10 minutes with use of an Eppendorf pipette while volatilizing the acetonitrile and after the coating, the electrode was left standing on a hot plate for 2 minutes to form a charge transport layer. At this time, the thickness of the charge transport layer formed was from 15 to 30 μm. Subsequently, Fused Salt (Y-1) was coated on this electrode and left standing for 10 hours under reduced pressure of 1,000 Pa or less and then, excess fused salt remaining on the surface was absorbed by a filter paper and removed. 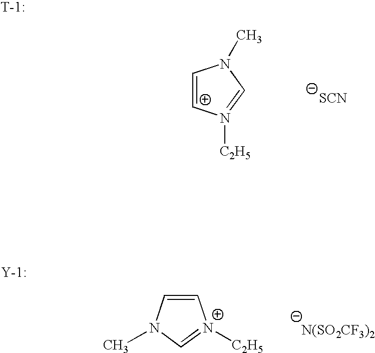
4. Production of Electromagnetic Wave Absorption/Photo-Electric Conversion Portion

An electrically conducting glass (produced by Nippon Sheet Glass Co., Ltd., 10 mm×25 mm, surface resistivity: 10 Ω/square) coated with a fluorine-doped tin oxide was superposed on the charge transport layer formed by the above-described operation, and these glasses were pinched with clips to produce an electromagnetic wave absorption/photoelectric conversion portion.

5. Measurement of Photoelectric Conversion Efficiency

A simulated sunlight was generated by passing light of a 500 W xenon lamp (manufactured by Ushio Inc.) through a spectral filter (AM1.5, manufactured by Oriel Corp.). The intensity of this light was 100 mW/cm². Thereafter, three units of the above-described electromagnetic wave absorption/photoelectric conversion portion were prepared and each was processed to take an ohmic contact. These three electromagnetic wave absorption/photoelectric conversion portions were laminated through a 1.3 μm-thick gelatin layer and assigned to a blue light layer, a green light layer and a red light layer from the side closer to the sunlight. Also, a layer formed by introducing a yellow colloidal silver into the gelatin layer between blue light layer and green light layer was prepared. This yellow colloidal silver layer was produced according to the production method of a yellow filter layer for color negative material described in JP-A-8-234895, paragraph [0086], and when the thickness was 1.3 μm, this yellow colloidal silver layer absorbed 75% of light at a wavelength of 400 to 500 nm. The simulated sunlight was irradiated through a blue-transmission filter (BPN-42 Filter) for three-color separation manufactured by Fuji Photo Film Co., Ltd. to effect blue light irradiation, and the electricity generated was measured by a current-voltage meter (Keithley Model SMU238) . It was found that the signal strength of the green light layer due to blue light irradiation was remarkably suppressed by the yellow colloidal silver layer of the present invention. Separately, the simulated sunlight was irradiated through a green-transmission filter (BPN-53 Filter) for three-color separation manufactured by Fuji Photo Film Co., Ltd. to effect green light irradiation, and the electricity generated was measured in the same manner. The signal strength of the green light layer upon green light irradiation was not changed at all by the yellow colloidal silver layer of the present invention.

From these tests, it was verified that when a yellow filter layer is introduced, mixing of blue light signal into the electrical signal of green light generated from the green light layer is decreased to elevate the saturation and moreover, the photosensitivity to green light is maintained. These test results are revealing that the color reproducibility of an image obtained by photographing a subject is enhanced and at the same time, the photographing sensitivity is maintained.

In this Example, test results on light-absorbing layers other than the yellow filter layer are not shown, but when the activities of yellow filter layer, ultraviolet absorbing layer, infrared absorbing layer, black visible light absorbing layer and fourth electromagnetic wave absorption/photoelectric conversion layer described in the foregoing pages are combined with the test results above on the yellow filter layer, it is apparent that the color reproduction and resolution are enhanced when an ultraviolet layer, an infrared absorbing layer, a black visible light absorbing layer or a fourth electromagnetic wave absorption/photoelectric conversion layer is provided in the stacked structure of at least three layers capable of absorbing and photoelectrically converting electro-magnetic waves of at least blue light, green light and red light.

It can also be similarly confirmed that the dynamic range is enhanced when the electromagnetic wave absorption/photoelectric conversion portion is separated into two layers of high-sensitivity layer and low-sensitivity layer.

1. An imaging sensor, which is a multipixel imaging sensor comprising an electromagnetic wave absorption/photoelectric conversion portion and a charge transfer/read-out portion, wherein
the electromagnetic wave absorption/photoelectric conversion portion has a stacked structure of at least three layers comprising a first layer capable of absorbing and photoelectrically converting blue light, a second layer capable of absorbing and photoelectrically converting green light, and a third layer capable of absorbing and photoelectrically converting red light, and
the electromagnetic wave absorption/photoelectric conversion portion further comprises at least one of an ultraviolet absorbing layer, an infrared absorbing layer, a black visible light absorbing layer, a fourth electromagnetic wave absorption/photoelectric conversion portion layer capable of absorbing light at a spectral wave length different from a spectral absorption wavelength of the three layers, and a yellow filter layer.

2. The imaging sensor according to claim 1, wherein the ultraviolet absorbing layer is disposed on an uppermost layer thereof.

3. The imaging sensor according to claim 1, wherein the infrared absorbing layer is disposed on an uppermost layer thereof.

4. The imaging sensor according to claim 1, wherein the black visible light absorbing layer is disposed on a lowermost layer thereof.

5. The imaging sensor according to claim 1, wherein the yellow filter layer is disposed as a lower layer of the electromagnetic wave absorption/photoelectric conversion portion.

6. An imaging sensor, which is a multipixel imaging sensor comprising an electromagnetic wave absorption/photoelectric conversion portion and a charge transfer/read-out portion, wherein
the electromagnetic wave absorption/photoelectric conversion portion has a stacked structure of at least three layers comprising a first layer capable of absorbing and photoelectrically converting blue light, a second layer capable of absorbing and photoelectrically converting green light, and a third layer capable of absorbing and photoelectrically converting red light, and
at least one layer of the electromagnetic wave absorption/photoelectric conversion portion comprises two or more layers of a high-sensitivity layer and a low-sensitivity layer.

7. The imaging sensor according to claim 1, wherein the charge transfer/read-out portion is a Group IV, III-V or II-VI semiconductor having a charge mobility of 100 cm²/V.s or more.

8. The imaging sensor according to claim 1, wherein the charge transfer/read-out portion is a silicon device.

9. The imaging sensor according to claim 1, wherein the charge transfer/read-out portion has one of a CMOS structure and a CCD structure.

10. The imaging sensor according to claim 1, wherein the electromagnetic wave absorption/photoelectric conversion portion comprises a unit comprising an organic compound film and light-transmitting electrodes sandwiching the film.

11. The imaging sensor according to claim 1, wherein the electromagnetic wave absorption/photoelectric conversion portion comprises a unit comprising an organic compound-inorganic compound mixed film and light-transmitting electrodes sandwiching the film.

12. The imaging sensor according to claim 1, wherein the electromagnetic wave absorption/photoelectric conversion portion comprises a unit comprising an inorganic compound film and light-transmitting electrodes sandwiching the film.

13. The imaging sensor according to claim 1, wherein the electromagnetic wave absorption/photoelectric conversion portion and the charge transfer/read-out portion are electrically connected by an electrically conducting material.
